(19) United States
(12) Patent Application Publication
(10) Pub. No.: US 2026/0350910 A1
(43) Pub. Date: Nov. 5, 2026

(54) LINEAR RAY TRACING

(71) Applicant: QUALCOMM Incorporated, San Diego, CA (US)

(72) Inventors: Shraman BISWAS, San Diego, CA (US); Alexei Vladimirovich BOURD, San Diego, CA (US); Amogha Udupa Shankaranarayana Gopal, Santa Clara, CA (US)

(21) Appl. No.: 19/196,672

(22) Filed: May 1, 2025

(51) Int. Cl. G06T 15/06; G06T 17/00

(52) U.S. Cl. CPC G06T 15/06; G06T 17/005; G06T 2210/21

(57) ABSTRACT

This disclosure provides systems, devices, apparatus, and methods, including computer programs encoded on storage media, for linear ray tracing. A graphics processor may obtain a depth map associated with an image, generate a bounding volume hierarchy (BVH) for the depth map, and perform a ray tracing operation based on the generated BVH for the depth map.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for software-based ray traversal may not achieve speeds achievable with hardware-based ray tracing. There is a need for improved hardware-based ray tracing techniques.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus a memory; and at least one processor coupled to the memory and, based at least in part on information stored in the memory, the at least one processor is configured to: obtain a depth map associated with an image, generate a bounding volume hierarchy (BVH) for the depth map, and perform a ray tracing operation based on the generated BVH for the depth map.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates is a diagram illustrating an example ray tracing process in accordance with one or more techniques of this disclosure.

FIG. 4A is a diagram illustrating an example rasterization process in accordance with one or more techniques of this disclosure.

FIG. 4B is a diagram illustrating an example ray tracing process in accordance with one or more techniques of this disclosure.

FIG. 5 is a diagram illustrating an example ray tracing process in accordance with one or more techniques of this disclosure.

FIG. 6A is a diagram illustrating an example data structure in accordance with one or more techniques of this disclosure.

FIG. 6B is a diagram illustrating an example data structure in accordance with one or more techniques of this disclosure.

FIG. 7A is a diagram illustrating an example BVH in accordance with one or more techniques of this disclosure.

FIG. 7B is a diagram illustrating another example BVH in accordance with one or more techniques of this disclosure.

FIG. 8 is a diagram illustrating a ray tracing operation associated with determining a closest hit texel on a depth buffer along a ray direction in accordance with one or more techniques of this disclosure.

FIG. 9 is a diagram illustrating a set of bounding volumes based on a depth image that may be used in association with a hardware (HW)-accelerated ray traversal in accordance with one or more techniques of this disclosure.

FIG. 10 is a diagram illustrating a simplified MIP mapping-like coalescing of child boxes to produce successive levels of parent boxes in accordance with one or more techniques of this disclosure.

FIG. 11 illustrates a use of alternating rectangular areas and/or regions for successive coalescing operations associated with generating a BVH structure in accordance with one or more techniques of this disclosure.

FIG. 12A is a diagram illustrating a first mapping of elements of a two-dimensional (2D) grid to a one-dimensional (1D) index or 1D linear array in accordance with one or more techniques of this disclosure.

FIG. 12B is a diagram illustrating a second mapping of elements of a 2D grid to a 1D index or 1D linear array that may be associated with a 2×2 coalescing operation in accordance with one or more techniques of this disclosure.

FIG. 12C is a diagram illustrating a third mapping of elements of a 2D grid to a 1D index or 1D linear array that may be associated with a 4×2 coalescing operation in accordance with one or more techniques of this disclosure.

FIG. 12D is a diagram illustrating a fourth mapping of elements of a 2D grid to a 1D index that may be associated with a 2×4 coalescing operation in accordance with one or more techniques of this disclosure.

FIG. 13 is a diagram illustrating an aspect of the BVH associated with some aspects of the HW-accelerated ray tracing in accordance with one or more techniques of this disclosure.

FIG. 14 is a communication flow diagram of graphics processing in accordance with one or more techniques of this disclosure.

FIG. 15 is a flowchart of an example method of graphics processing in accordance with one or more techniques of this disclosure.

FIG. 16 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

Ray tracing may refer to a technique for generating an image by tracing a path of light as the light bounces off an object. Ray tracing may be utilized to produce realistic lighting effects in various applications, including video game applications. In order to perform ray tracing, a device (e.g., a GPU) may traverse a bounding volume hierarchy (BVH). A BVH may refer to a tree structure on a set of geometric objects that are each recursively wrapped in bounding volumes until the entire set of geometric objects is wrapped in a single bounding volume. A traversal of the BVH may be referred to as a BVH traversal. During a BVH traversal with respect to a ray, an infinite loop may run until a triangle is hit which ends the traversal. As such, at a compile time, an upper limit of a number of iterations of the BVH traversal may not be known. As used herein, a compile time may refer to a period of time at which instructions are compiled (or prepared to be compiled) into machine-readable instructions. As used herein, a loop may refer to a control flow statement that specifies or is associated with an iteration. Loops may include for loops and while loops. A loop may include a specified or an unspecified number of iterations. A loop may be utilized to avoid duplication(s) of instructions.

Loop unrolling (i.e., unrolling a loop) may refer to a technique that attempts to optimize an execution speed of a program by reducing or eliminating instructions that control a loop, such as pointer arithmetic, end of loop tests on iterations of the loop, reducing branch penalties, and/or hiding latencies. As noted above, for a BVH traversal, an upper limit of a number of iterations of the BVH traversal may not be known. This may prevent a compiler from unrolling a loop associated with the BVH traversal. Failing to unroll a loop may impact a performance of a BVH traversal due to increased loop overhead.

Various technologies pertaining to determining the closest hit texel on a depth buffer along a ray direction are described herein. Determining the closest hit texel on a depth buffer along a ray direction may be done using ray marching, which may utilize many steps. In some aspects presented herein, determining the closest hit texel on a depth buffer along a ray direction may include replacing inefficient ray marching with HW-accelerated ray traversal. This may be done by representing the depth image as a height map, constructing a BVH over the height map, and ray tracing over the BVH to obtain the closest hit. The implementation, in some aspects, may involve dividing the depth image into tiles, down-sampling, converting depth samples to height values via range inversion, and using a modified Morton order for BVH memory traversal. In an example, an apparatus (e.g., a GPU), obtains a depth map associated with an image, generates a bounding volume hierarchy (BVH) for the depth map, and performs a ray tracing operation based on the generated BVH for the depth map. As used herein, a depth map may refer to a set of pixels and/or texels (e.g., a 2D array of pixels/texels) each associated with a value (e.g., an 8-bit or 16-bit depth value) indicating a depth from a “screen” representing a displayed image. In some aspects, a depth map may be visualized as a depth image using the depth values of the depth map as intensity values for the set of pixels and/or texels. A height map may be generated based on a corresponding depth map (or depth image) and, as used herein, a height map may refer to a set of pixels and/or texels (e.g., a same 2D array of pixels/texels as the 2D array of pixels/texels of the corresponding depth map and/or depth image) each associated with a value (e.g., an 8-bit or 16-bit height value) indicating a height from a “floor” of a reference plane and/or surface, where a height value for a pixel and/or texel in the height map may be calculated based on a corresponding pixel and/or texel in the corresponding depth map. For example, in some aspects, the height value for a pixel and/or texel in the height map may be based on an inversion of a depth value for the corresponding pixel and/or texel in the corresponding depth map. As used herein, a footprint, or base, of a BVH, a BVH node, bounding volume, or bounding box, refers to an area or region of the depth image associated with the BVH. As used herein, a coalescing operation or coalescing may refer to an operation associated with aggregating, combining, and/or summarizing data associated with multiple inputs into a single output, where the operation may be a Min( ) or Max( ) operation identifying, respectively, a minimum value in a set of input values or a maximum value in a set of input values. As used herein, a traversal may indicate an order for reading and/or storing elements of group of units (e.g., pixels/texels, BVH nodes, etc.). As used herein, a BVH structure may refer to the relationship between child and parent nodes without considering (height) values associated with each element of the BVH structure. As used herein a ray tracing operation or ray tracing process, may refer to any operation and/or process used to identify and/or determine an intersection between a ray (e.g., a linear path from a ray origin in a particular direction) and a closest hit object, pixel, and/or texel associated with an image. For example, as used herein, a ray tracing operation or ray tracing process, may refer to any operation and/or process for tracing a path of light (e.g., a ray from a light source or from a ray origin associated with a location from which ray intersections with one or more objects in an image are assessed) for the pixels and/or texels in an image plane (e.g., an image plane associated with a field of view from a set of ray origins for which the ray tracing operation and/or process is performed) to detect a closest hit pixel and/or texel. In some aspects, a ray tracing operation and/or process may refer, collectively, to a plurality of individual ray tracing operations and/or processes associated with rendering a single image. For example, a ray tracing operation and/or process for an image may refer to a plurality of ray tracing operations and/or processes for a corresponding plurality of pixels and/or texels of the image. In some aspects, the ray tracing operations and/or processes may be associated with, or use, an acceleration structure such as the BVH described above to determine a ray intersection.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

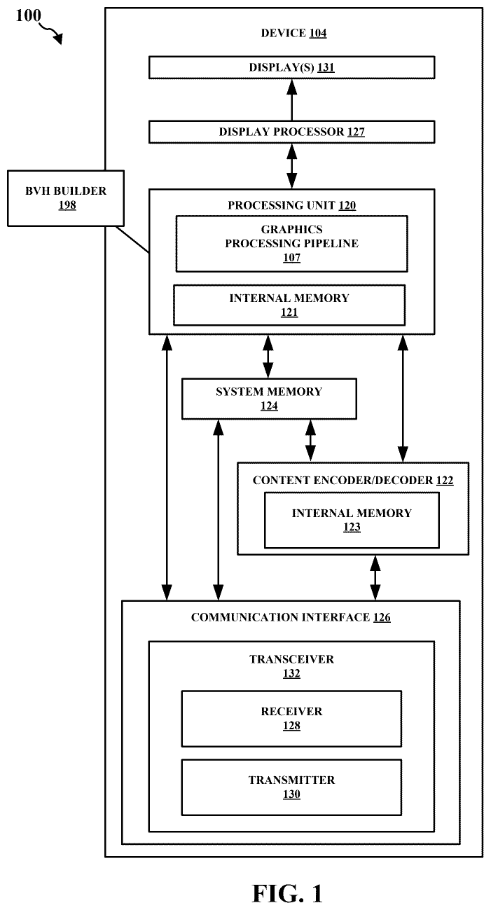

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content. The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a BVH builder 198 configured to obtain a depth map associated with an image, generate a BVH for the depth map, and perform a ray tracing operation based on the generated BVH for the depth map. Although the following description may be focused on graphics processing, the concepts described herein may be applicable to other similar processing techniques. Furthermore, although the following description may be focused on ray tracing, the concepts presented herein may also be applicable to other types of tracing as well (e.g., path tracing).

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

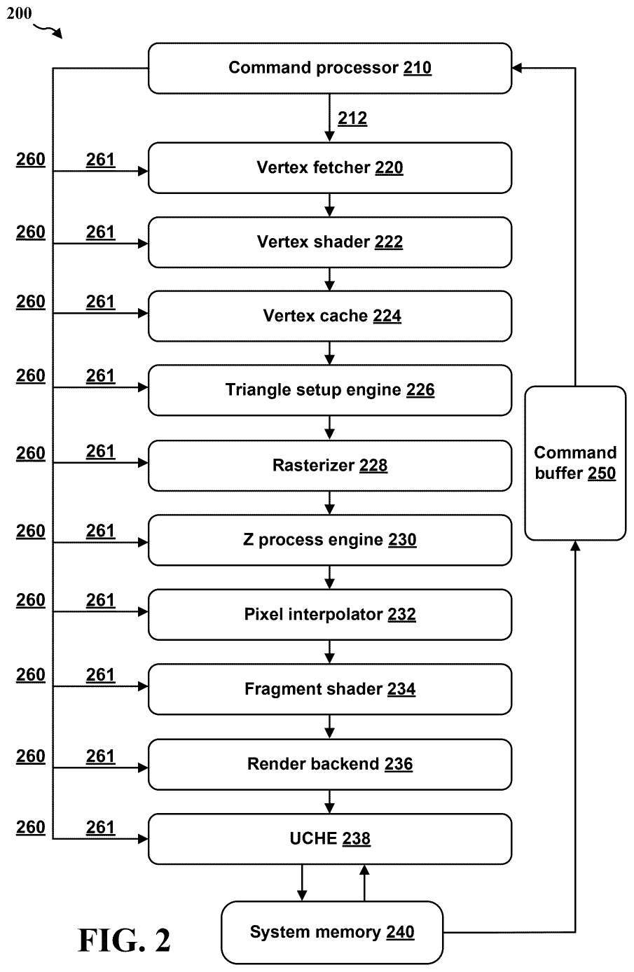

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

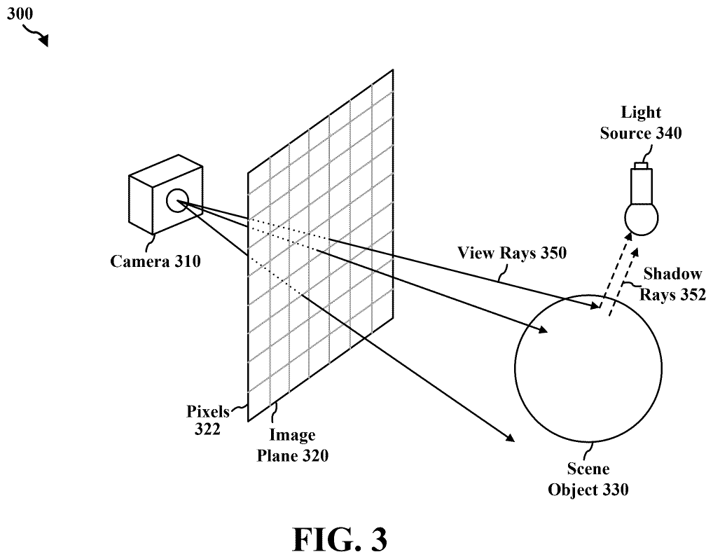

FIG. 3 illustrates diagram 300 including one example of a ray tracing process. As shown in FIG. 3, diagram 300 includes camera 310, image plane 320 including pixels 322, scene object 330, light source 340, view rays 350, and shadow rays 352. FIG. 3 shows that view rays 350 are traced from camera 310 and through image plane 320. After passing image plane 320, the view rays 350 are traced to scene object 330. At least some of the view rays 350 are traced off of scene object 330 and are traced towards light source 340 as shadow rays 352. Accordingly, the shadow rays 352 and view rays 350 may trace the light from light source 340. FIG. 3 depicts how ray tracing may generate an image by tracing the path of light (e.g., from light source 340) for the pixels in an image plane (e.g., pixels 322 in image plane 320).

Ray tracing is distinguishable from a number of other rendering techniques utilized in graphics processing, such as rasterization. In the process of rasterization, for each pixel in each primitive in a scene, the pixel may be shaded if a portion of the pixel is covered by the primitive. In contrast, in the process of ray tracing, for each pixel corresponding to a primitive in a scene, a ray is generated. If the generated ray is determined to hit or strike a certain primitive, then the pixel is shaded. In some instances of graphics processing, ray tracing algorithms may be performed alongside rasterization, such as via a hybrid ray tracing/rasterization model.

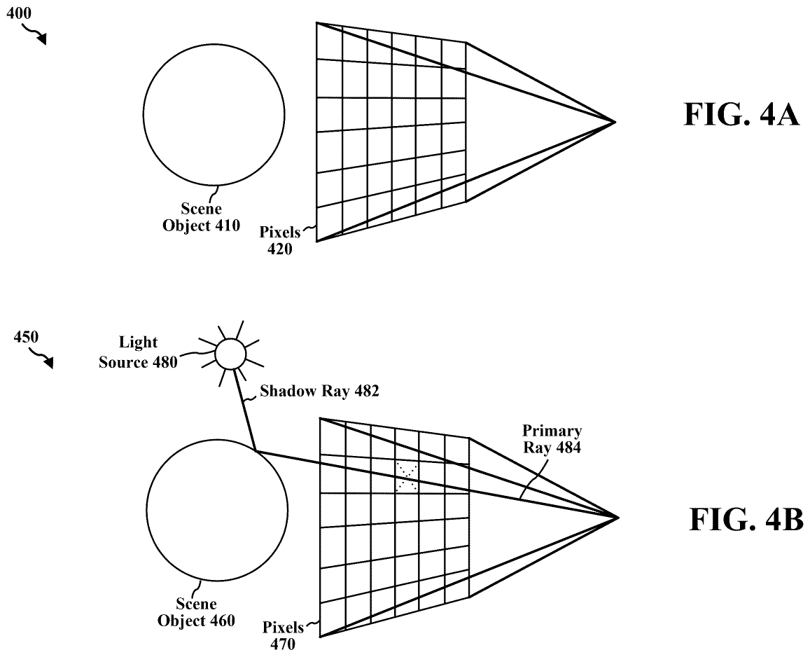

FIG. 4A and FIG. 4B illustrate a diagram 400 and a diagram 450 including an example process of rasterization and an example process of ray tracing, respectively. As shown in FIG. 4A, diagram 400 includes scene object 410 and pixels 420. FIG. 4A depicts that the process of rasterization determines, for each of pixels 420 in a scene including scene object 410, a pixel is shaded if a portion of the pixel is covered by a primitive. As shown in FIG. 4B, diagram 450 includes scene object 460, pixels 470, light source 480, shadow ray 482, and primary ray 484. FIG. 4B depicts that the process of ray tracing determines if a generated ray (e.g., shadow ray 482) will hit or strike a certain primitive in scene object 460 corresponding to one of the pixels 470 via primary ray 484, then the pixel is shaded.

As indicated herein, the process of ray tracing may be performed by determining whether a ray will hit/strike any primitive(s) in a scene. For example, ray tracing algorithms may perform a simple query operation: Is a given ray going to hit/strike any primitive(s) in a scene? The process of ray tracing is computationally intensive, as a large amount of rays may be traced against a large number of primitives/triangles, which may utilize a large number of ray-triangle intersection tests. For example, in one ray tracing procedure, approximately 1 million rays may be traced against approximately 1 million primitives/triangles, which may utilize approximately 1 trillion ray-triangle intersection tests. In some aspects of ray tracing procedures, an origin point for a given ray may be represented by O(N). Further, there may be a number of values calculated for the ray, such as a minimum time to strike primitives in a scene (tₘᵢₙ), a maximum time to strike primitives in a scene (tₘₐₓ), and a calculated distance to strike primitives in the scene.

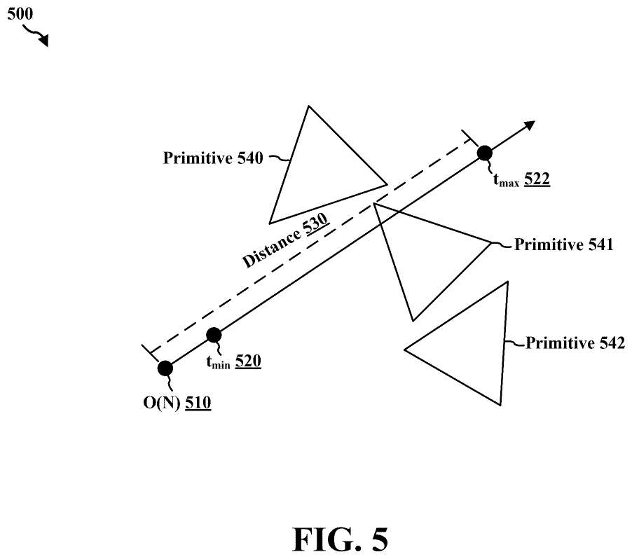

FIG. 5 illustrates a diagram 500 including one example of a ray tracing process. As shown in FIG. 5, the diagram 500 includes origin point for a ray (O(N) 510), a minimum time to strike primitives in a scene (tₘᵢₙ 520), a maximum time to strike primitives in a scene (tₘₐₓ 522), a calculated distance to strike primitives in the scene (distance 530), and a number of primitives (primitive 540, primitive 541, and primitive 542) in the scene. FIG. 5 shows that ray tracing techniques may utilize a number of values to determine if a ray is going to hit a primitive. For instance, to determine if a ray will strike a primitive, ray tracing techniques may utilize an origin point for a ray (O(N) 510), a minimum time to strike primitives (tₘᵢₙ 520), a maximum time to strike primitives (tₘₐₓ 522), a calculated distance to strike primitives (distance 530), and a number of primitives (primitive 540, primitive 541, and primitive 542).

Ray tracing may utilize various data structures for accelerating a computational process, such as a bounding volume hierarchy (BVH). In a bounding volume hierarchy, primitives are held in leaf nodes. Further, internal nodes may hold axis-aligned bounding boxes (AABBs) that enclose certain leaf node geometry. Data structures for ray tracing may also utilize a ray-box intersection for internal nodes and/or a ray-triangle test for leaf nodes. These types of data structures may reduce the computational complexity (N) of the ray tracing process, e.g., reduce the computational complexity (N) by log (N).

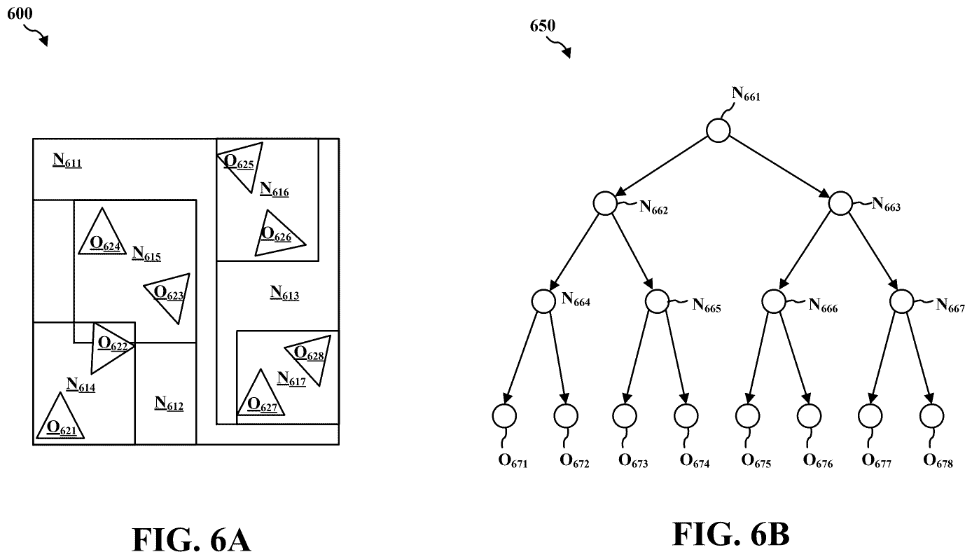

FIG. 6A and FIG. 6B illustrate a diagram 600 and a diagram 650, respectively, including example data structure techniques utilized in ray tracing. As shown in FIG. 6A, diagram 600 includes a number of nodes (internal nodes N₆₁₁-N₆₁₇) and a number of primitives (primitives O₆₂₁-O₆₂₈). FIG. 6A depicts a ray-box intersection for internal nodes N₆₁₁-N₆₁₇ and primitives O₆₂₁-O₆₂₈. As shown in FIG. 6B, diagram 650 includes a number of nodes (leaf nodes N₆₆₁-N₆₆₇) and a number of primitives (primitives O₆₇₁-O₆₇₈). FIG. 6B depicts a ray-triangle test for leaf nodes N₆₆₁-N₆₆₇ and primitives O₆₇₁-O₆₇₈. Both of the data structure techniques in FIGS. 6A and 6B, e.g., the ray-box intersection and the ray-triangle test, aim to reduce the computational complexity in ray tracing.

As indicated herein, there are a number of different stages during a ray tracing process. For example, the stages of ray tracing may include: bounding volume hierarchy construction and refinement, ray generation, bounding volume hierarchy traversal, ray-triangle intersection, and ray-box intersection. There may also be different steps during bounding volume hierarchy construction, including partitioning triangles into multiple groups, forming a bounding box around each group, and recursively partitioning each group. Additionally, there may be several ways to partition during bounding volume hierarchy construction, which may result in a certain number of possible solutions, e.g., 2n log n solutions. As a result, these improved solutions may yield improved ray tracing performance.

Aspects of ray tracing may also utilize a number of bounding volume hierarchy algorithms, such as split bounding volume hierarchy (SBVH) and linear bounding volume hierarchy (LBVH). In some instances, an SBVH may result in slower build times and better quality compared to an LBVH. Likewise, an LBVH may result in faster build times and poorer quality compared to an SBVH. Additionally, some aspects of ray tracing may utilize bounding volume hierarchy refinement. In bounding volume hierarchy refinement, given a binary BVH with one triangle per leaf, ray tracing techniques may permute the tree topology. Bounding volume hierarchy refinement may utilize different algorithms, e.g., a treelet restructuring BVH (TRBVH) and a parallel reinsertion BVH (PRBVH). Some aspects of ray tracing may also utilize BVH widening, which may convert a binary tree (i.e., an initial BVH) to a wide BVH that is wider than the binary tree or initial BVH. For example, hierarchy in the initial BVH may include three levels, where the primitives are included in a third level of the hierarchy. The hierarchy in the wide BVH may include two levels, where the primitives are included in a second level of the hierarchy. In some instances of BVH widening, the wide BVH may include an internal node with a certain amount of AABBs (e.g., up to eight AABBs) and a leaf node with a certain amount of primitives/triangles (e.g., up to four primitives/triangles).

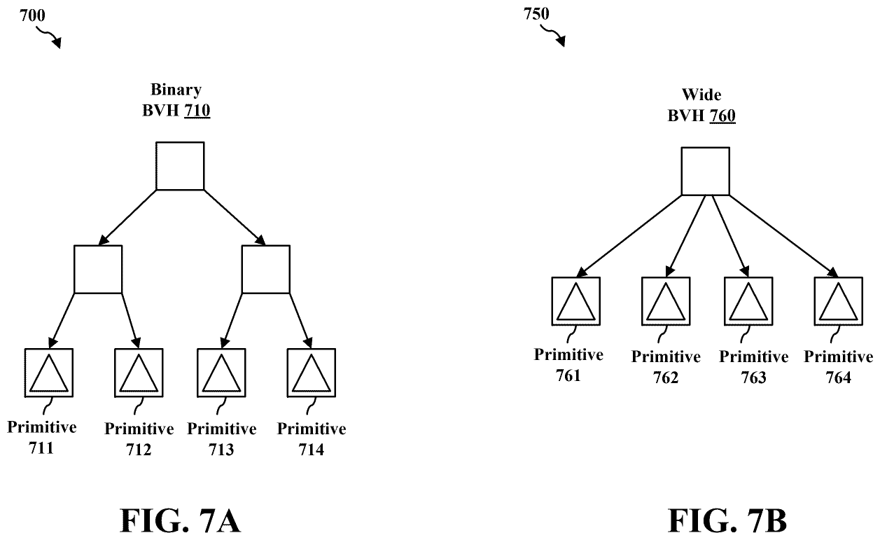

FIG. 7A and FIG. 7B illustrate a diagram 700 and a diagram 750 including a binary bounding volume hierarchy and a wide bounding volume hierarchy, respectively. As shown in FIG. 7A, diagram 700 includes a binary bounding volume hierarchy 710 including primitive 711, primitive 712, primitive 713, and primitive 714. FIG. 7A depicts that binary bounding volume hierarchy 710 includes three levels, where primitives 711-714 are in the third level of the hierarchy. As shown in FIG. 7B, diagram 750 includes a wide bounding volume hierarchy 760 including primitive 761, primitive 762, primitive 763, and primitive 764. FIG. 7B depicts that wide bounding volume hierarchy 760 includes two levels, where primitives 761-764 are in the second level of the hierarchy. As shown in FIGS. 7A and 7B, binary bounding volume hierarchy 710 may undergo a process of bounding volume hierarchy widening that results in wide bounding volume hierarchy 760.

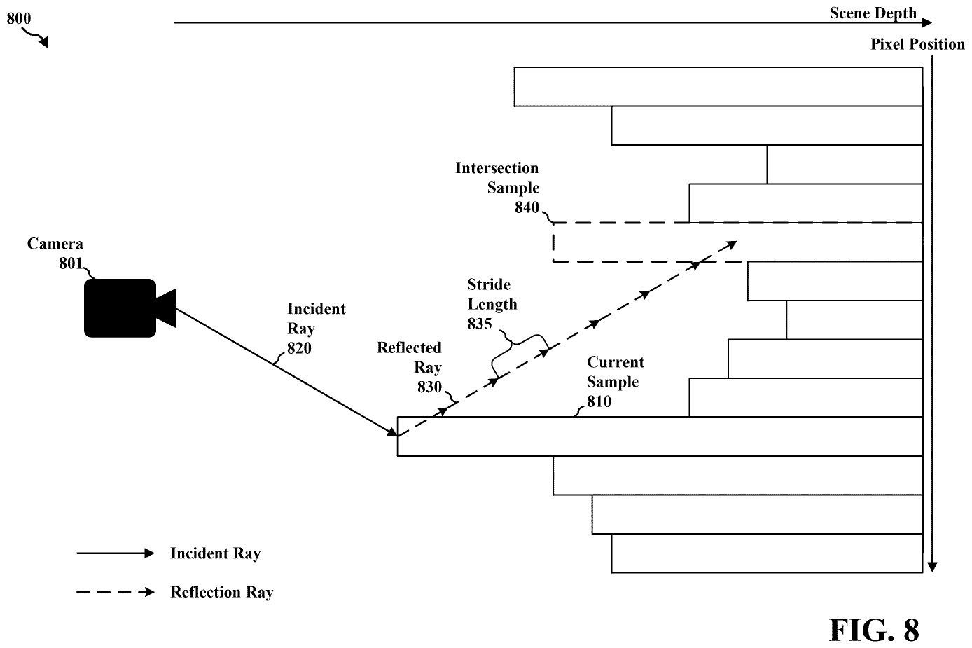

FIG. 8 is a diagram 800 illustrating a ray tracing operation associated with determining a closest hit texel on a depth buffer along a ray direction. A ray tracing operation associated with determining a closest hit texel (or pixel) on a depth buffer along a ray direction may be associated with a ray origin at any location (e.g., a camera origin, texture space, etc.). The input, in some aspects, may be a depth image (or depth map). The depth image (or depth map) may be stored in a scene depth buffer. In some aspects, a depth image or depth map may be, for example, an 8-bit or 16-bit depth image (e.g., a bmp or png file) with a width of a first number of pixels/texels and a length of a second number of pixels/texels, where the width and depth may be the same (e.g., 1024×1024) or different (e.g., 1920×1080). The output of the ray tracing operation, in some aspects, may be a closest hit pixel/texel (e.g., coordinates of the closest hit pixel/texel within the image).

Diagram 800 illustrates a simplified ray marching (e.g., along a single dimension) used to determine (solve for) a closest hit pixel. The simplified ray marching illustrated for a single dimension may be extended to a two-dimensional depth image based on the same principles. The ray marching, in some aspects, may be associated with a screen space reflection (SSR) operation and/or technique. From a camera 801, the ray tracing operation may determine an incident ray 820 associated with a current sample 810. From the current sample 810, the ray tracing may identify a reflected ray 830 based on the incident ray 820. To determine the closes hit pixel/texel (e.g., intersection sample 840), the ray tracing operation may take steps in the direction of the reflected ray 830, the steps may be of a fixed size (e.g., stride length 835) selected to not miss a closest hit pixel/texel or may be of varying size (not illustrated). Some rays may utilize many steps (e.g., ~1400 steps for a single-pixel step size used to traverse a diagonal of a 1024×1024 image or depth map). In some aspects, a varying number of steps may lower single instruction, multiple data (SIMD) arithmetic logic unit (ALU) utilization. In some aspects, this may also produce high miss rates (e.g., texture L1 cache) and lead to a high single-step latency.

In some aspects, the inefficient ray marching described above may be replaced by hardware accelerated (HW-accelerated) ray traversal. For example, HW-accelerated ray traversal may be used to replace screen-space ray marching (which may otherwise be done via a shader and/or software) and or disocclusion handling (e.g., “hole filling”) after image warping (e.g., for an extended reality (XR) use case) such as for an SSR technique and/or operation. A naïve and/or straightforward approach may use procedural geometry to build and/or update a BVH. For example, an image that is 1024 pixels/texels by 1024 pixels/texels may be associated with approximately one million pixels/texels that may be referred to, or identified, as nodes of the BVH. However, using approximately one million nodes may be too slow and a traversal may also be inefficient (e.g., the traversal may exit an optimized traversal loop and return control to the entity and/or software calling the HW-accelerated traversal such as a shader which may decide a ray-box intersection commitment).

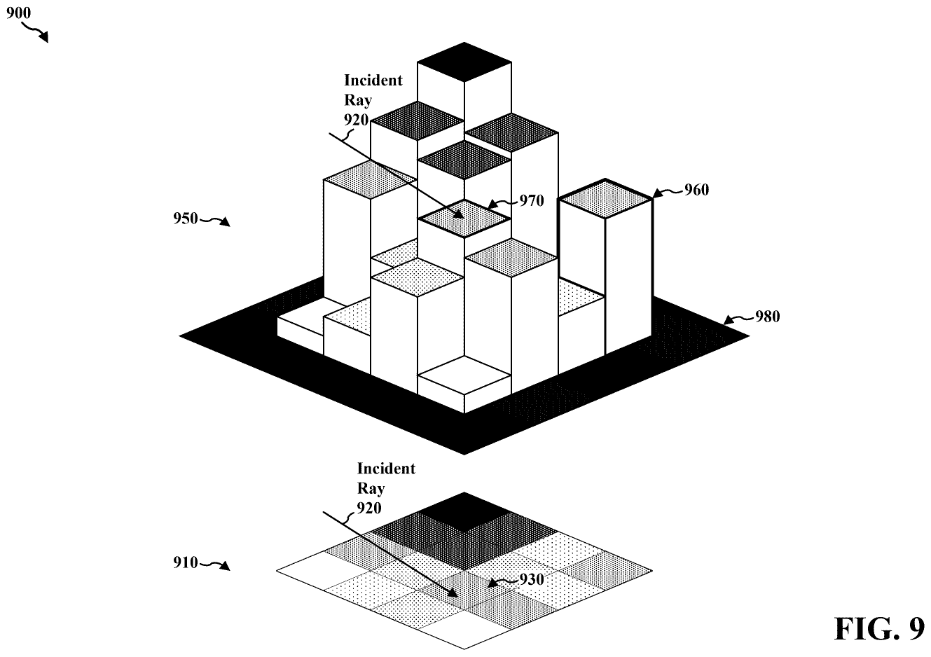

FIG. 9 is a diagram 900 illustrating a set of bounding volumes based on a depth image that may be used in association with a HW-accelerated ray traversal. Diagram 900 illustrates an example depth image 910 (e.g., a 4×4 depth image or depth map) where darker pixels/texels are associated with greater heights. In some aspects, the depth image may be associated with a depth range [0,1] which may be inverted to obtain an associated height in a range [255,0] (e.g., for an 8-bit image) or [65535,0] (e.g., for a 16-bit image). The depth image may be converted to a height map 950 (or height map) including a box, or bounding volume (e.g., a bounding volume 960), associated with each pixel/texel. For example, a position of each box may be identified as the position of the pixel/texel (e.g., a pixel/texel coordinate), the base of each box may be the pixel/texel size and/or dimensions, and the box height may be the inverted pixel/texel value (as described above), where the height may be specified relative to, or measured from, a reference surface and/or plane such as plane 980.

Based on the height map 950, a BVH may be constructed, and the HW-accelerated ray traversal and/or ray tracing may be performed. For example, for an incident ray 920, the height map 950 may be used to identify pixel/texel 970 (e.g., corresponding to pixel/texel 930) as the intersecting pixel/texel. The BVH constructed based on the height map 950 (or similar height maps constructed based on pixels/texels of a depth image or depth map) may result in a balanced k-dimensional (K-D) tree with non-overlapping boxes (or bounding volumes) such that a closest hit is a first leaf hit. The balanced K-D tree, in some aspects, may allow parallel BVH construction. The BVH structure may be deterministic such that, for images of a particular size (e.g., width and height), the BVH structure may be determined (i.e., may be the same). In some aspects, for a series of related images of a same size, a BVH structure may be computed once and used for the series of related images, e.g., by updating height (“Z”) values associated with each leaf (or a set of leaves with changes to the Z-value) and propagating the changes through the associated nodes (or bounding volumes) in the BVH.

In some aspects, current ray tracing application programming interfaces (APIs) (buildBVH, updateBVH, and traceRays) may not be sufficient and/or suited for HW-accelerated ray tracing for depth images and/or depth maps. Updated versions of the ray tracing APIs may be provided in some aspects and/or integrated with/into a GPU-based ray tracing (GRT) framework. For example, the updated APIs may include a buildBVH API used to construct a complete BVH once during a startup process for a set of similarly sized images, an updateBVH API used to update the leaf node Z-values as fast as possible per frame, and a traceRays API used to trace camera rays over the BVH to determine the closest hit. In designing the updated APIs, in some aspects the buildBVH API may be allowed to be relatively slow, the updateBVH API may be designed to be as fast as possible, and the buildBVH and updateBVH APIs may be designed to provide “good” BVH spatial volume/layout for the traceRays API.

In some aspects, an updated buildBVH API may coalesce groups of neighboring child boxes into a parent and recursively generate higher levels of the BVH. For example, pseudocode for a particular coalescing operation may include the following operations:

$$parent\_box \_position := child0\_box \_position$$

$$parent\_box \_base := union ( child0\_box \_base , … , childN\_box \_base )$$

$$parent\_box \_height := max ( child0\_box \_height , … , childN\_box \_height )$$

Based on the above pseudocode a balanced K-D tree may be generated. As described above in the pseudocode, the buildBVH may be based on a multum in parvo (MIP) mapping-like, or mipmapping-like, operation. For example, the buildBVH API may generate a full MIP chain (up to 12 levels) in a single kernel.

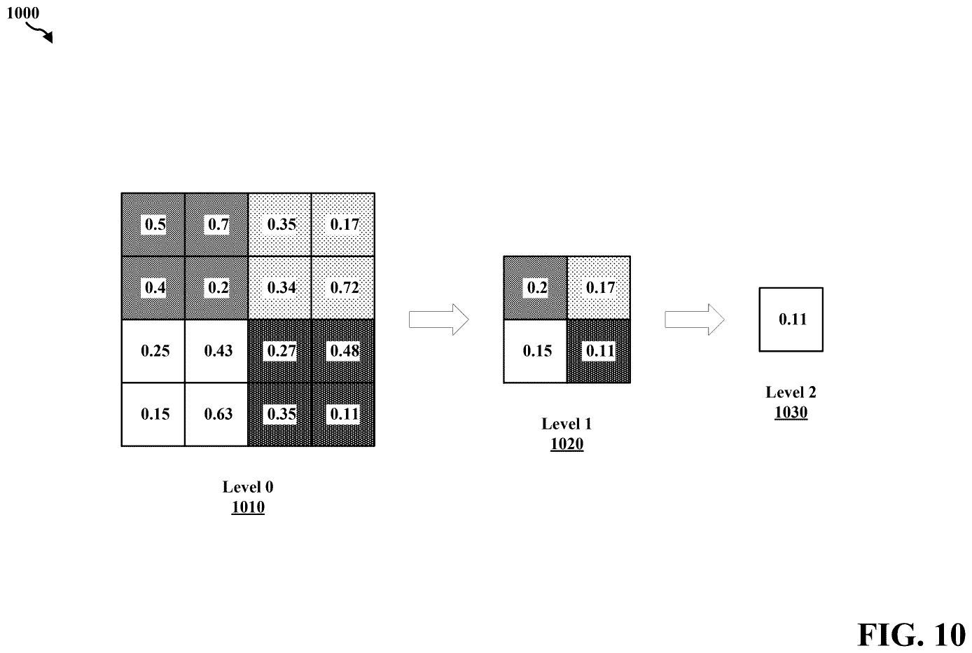

FIG. 10 is a diagram 1000 illustrating a simplified MIP mapping-like coalescing of child boxes to produce successive levels of parent boxes. Diagram 1000 illustrates that a first set of boxes at a lowest level 1010 (e.g., level 0), may be coalesced into a second set of boxes at a next level 1020 (e.g., level 1). Each similarly shaded box in the lowest level 1010 may be coalesced into a similarly shaded box in the next level 1020, where the labels in each box may be a depth value (e.g., an inverse of a height value or Z-value) associated with the box. Each box at the next level 1020 may be associated with a minimum depth value (e.g., a greatest height or highest Z-value) of the associated, or coalesced, child boxes. Similarly, the set of boxes at the next level 1020 (e.g., level 1), may be coalesced into an additional set of boxes at an additional level 1030 (e.g., level 2) associated with a minimum depth value of the child boxes (e.g., at level 1).

In some aspects, an algorithm associated with a buildBVH API may include dividing a depth image into tiles (e.g., dividing a 1024×1024 pixels/texel depth image into 64×64 pixel/texel tiles). Each tile may be assigned to a workgroup (e.g., on a 1-tile-per-workgroup) to be down-sampled (e.g., coalesced) in stages. For each 64×64 pixel/texel tile, the coalescing and/or down-sampling stages may result in a BVH structure including levels having (e.g., depth/height “images” and/or height maps/depth maps) of 16×32, 8×8, 2×4, and 1×1 nodes, boxes, and/or bounding volumes. In some aspects, each level is stored as an internal BVH node in the BVH (which may be referred to as an acceleration structure or AS). In the example above for a 1024×1024 image divided into a 16×16 tile structure with 64×64 pixels/texels per tile, each tile may become one box in the BVH (e.g., at a specific level of the BVH having a size of 16×16 boxes). Additional down-sampling and/or coalescing stages may be applied to the boxes corresponding to the tiles by an additional workgroup may further down-sample (e.g., coalesce) resulting in a BVH structure including levels having (e.g., depth/height “images” and/or height maps/depth maps) of 4×8, 2×2, and 1×1 nodes, boxes, and/or bounding volumes.

In contrast to the MIP mapping, or mipmapping, illustrated in FIG. 10, in some aspects, the coalescing, for at least some levels of the BVH, may not be based on a square area/region of a depth image (or depth map) or a child “box” and may instead be based on a rectangular area/region of the depth image (or depth map) or the child “box.” The number of pixels/texels and/or boxes/nodes of a first (e.g., child) level that is coalesced into a next higher (e.g., parent) level, in some aspects, may be based on the architecture of the HW (e.g., GPU) implementing the buildBVH API and/or the HW-accelerated ray tracing. For example, for a HW architecture that supports 8 children-per-parent in association with the BVH, an area/region for coalescing may include 8 elements (e.g., pixels/texels, boxes, nodes, etc.) that may be an 8×1, 4×2, 2×4, or 1×8 rectangular area/region. In some aspects, using either an 8×1 or 1×8 rectangular area/region may produce long and thin parents that are associated with poor traversal for the ray tracing operation. Using the 4×2 or 2×4 rectangular area/region may similarly produce long and thin parents (but less long and thin than associated with the 8×1 or 1×8 rectangular area/region) that may be associated with a ray traversal that is not as efficient as a ray traversal based on a square area/region (other variable being equal), but more efficient than the ray tracing operation associated with the 8×1 or 1×8 rectangular area/region.

To mitigate the effects of using a rectangular area/region, the rectangular area/region used for alternating coalescing operations may be transposed between operations. For example, a first coalescing operation associated with a first level may be associated with a 4×2 rectangular area/region while a second coalescing operation associated with a second level may be associated with a 2×4 rectangular area/region, where the resulting node or box covers an 8×8 square area/region of the child of the first level. Additional odd levels may be associated with coalescing operations associated with the 4×2 rectangular area/region and even levels may be associated with coalescing operations associated with the 2×4 rectangular area/region such that the coalesced boxes associated with the even levels have square bases while the coalesced boxes associated with the odd levels have rectangular bases. In some aspects, using alternating 4×2 and 2×4 rectangular area/regions to minimize the deviation from square bases for the boxes associated with the odd levels.

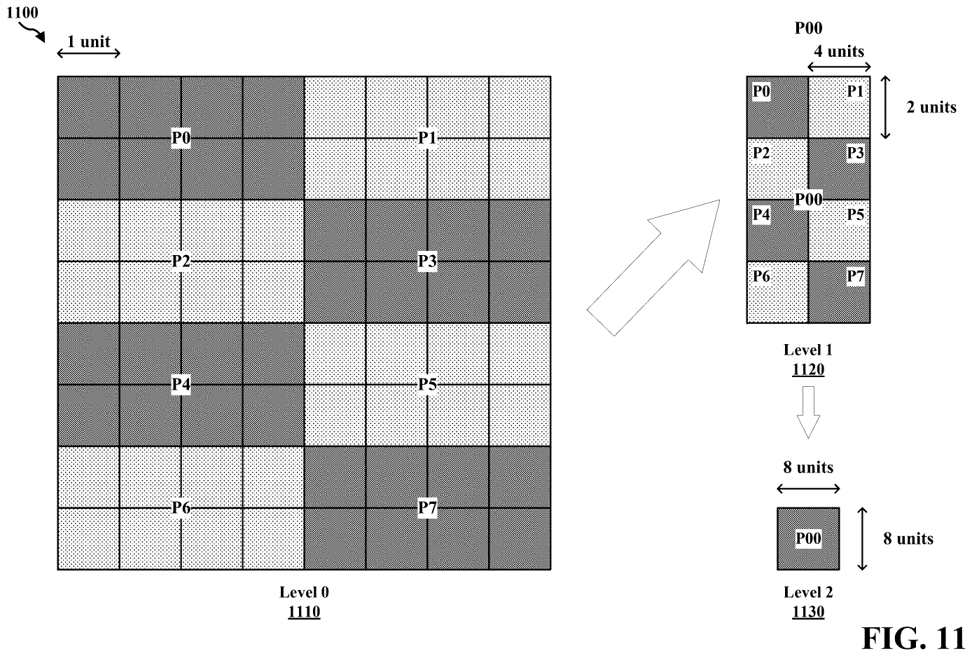

FIG. 11 is a diagram 1100 illustrating a use of alternating rectangular areas and/or regions for successive coalescing operations associated with generating a BVH structure. FIG. 11 illustrates a first set of pixels/texels, nodes, or boxes associated with a first level 1110 of a BVH structure (e.g., level 0). The first level, in some aspects, may represent a set of pixels and/or texels in a depth image (or depth map), or a box/node defined for, or associated with, a particular level of the BVH and spanning multiple pixels/texels in width and height (e.g., assumed to be a square region in this example). As illustrated, the units at the first level 1110 may be coalesced based on a 4×2 rectangular area/region into a set of 8 coalesced units (e.g., P0 to P7) at a parent level 1120 (e.g., level 1) that each have a footprint (or base) of 4×2 units (as defined at the first level 1110).

The set of 8 coalesced units at the parent level 1120 may be coalesced based on a 2×4 rectangular area/region into an additional coalesced unit (e.g., P00) at a next parent level 1130 (e.g., level 2). The additional coalesced unit (e.g., P00) may have a footprint (or base) of 8×8 units (as defined at the first level 1110). FIG. 11 illustrates the use of a rectangular area/region based on a transposition between alternating coalescing operations.

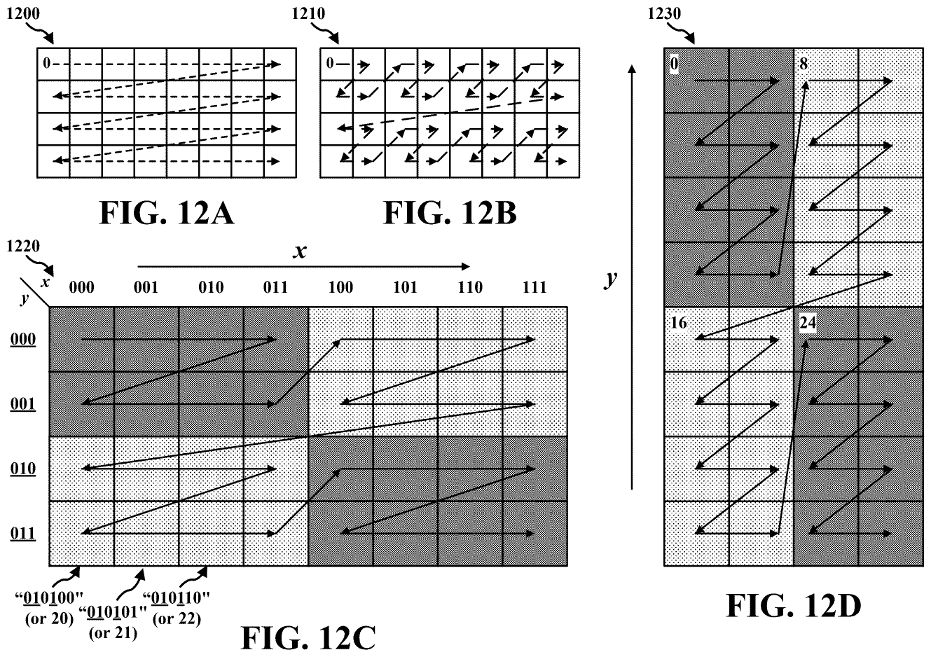

In some aspects, the alternating scheme illustrated in FIG. 11 may be more complicated to implement. For example, the level of the BVH (or a MIP level) may determine which orientation of the rectangular area/region, or 2D layout (e.g., 4×2 or 2×4), is used and/or selected for a coalescing operation in which child boxes are sampled based on the determined and/or selected orientation of the rectangular area/region (and with an appropriate stride). In some aspects, a mapping from units in the rectangular area/region (e.g., a 2D set of units) to an indexed (e.g., along a single, or linear, dimension) set of memory location may be used to store data (e.g., depth values or Z-values) for each child box into a memory associated with the BVH (e.g., a parent node of the BVH). FIG. 12A is a diagram 1200 illustrating a first mapping of elements of a 2D grid to a 1D index or 1D linear array. Diagram 1200 illustrates a “linear order” mapping that proceeds from a 0^{th} unit and goes across and then down until all units have been traversed. For a set of units arranged in a 2D grid having a largest dimension that can be expressed in n bits, the index z may be a 2n-bit value constructed based on the n bits (e.g., yₙ . . . y₂y₁y₀, with yₙ being a most significant bit) indicating a position along a first axis and/or direction (e.g., an “up” and “down” direction or a y-axis) and the n bits (e.g., xₙ . . . x₂x₁x₀) indicating a position along a second axis and/or direction (e.g., a “left” and “right” direction or an x-axis) such that by appending one set of the n bits (e.g., either the x or y bits) after the other set of bits (e.g., either the y or x bits, respectively) the values of the index, e.g., z=yₙ . . . y₂y₁y₀|xₙ . . . x₂x₁x₀ may correspond to the traversal pattern (e.g., across and then down) illustrated in diagram 1200 (where putting the x bits first would scan down and then across).

FIG. 12B is a diagram 1210 illustrating a second mapping of elements of a 2D grid to a 1D index or 1D linear array that may be associated with a 2×2 coalescing operation. Diagram 1210 illustrates a “Morton order” mapping that proceeds in the direction of the dashed lines/arrows which maps groups of four adjacent units (e.g., units that may be coalesced in a mipmapping operation) to contiguous indexes of the 1D index (locations in the 1D linear array). The “Morton order” mapping may be based on, or associated with, an index z into the 1D linear array (e.g., a 1D index). For a set of units arranged in a 2D grid having a largest dimension that can be expressed in n bits, the index z may be a 2n-bit value constructed based on the n bits (e.g., yₙ . . . y₂y₁y₀, with yₙ being a most significant bit) indicating a position along a first axis and/or direction (e.g., an “up” and “down” direction or a y-axis) and the n bits (e.g., xₙ . . . x₂x₁x₀) indicating a position along a second axis and/or direction (e.g., a “left” and “right” direction or an x-axis) such that z=yₙxₙ . . . y₂x₂y₁x₁y₀x₀.

FIG. 12C is a diagram 1220 illustrating a third mapping of elements of a 2D grid to a 1D index or 1D linear array that may be associated with a 4×2 coalescing operation. Diagram 1220 illustrates a first modified “Morton order” mapping (or a first traversal pattern) that proceeds in the direction of the lines/arrows which maps groups of 8 adjacent units (e.g., contiguous and/or adjacent units shown as having a same shading associated with the 4×2 coalescing operation) to contiguous indexes of the 1D index (locations in the 1D linear array) corresponding to the 8 child nodes of a parent node in the HW structure described above. For example, the first modified “Morton order” mapping may be based on, or associated with, an index z into the 1D linear array (e.g., a 1D index). For a set of units arranged in a 2D grid indexed as described above (and illustrated in diagram 1220) the index z may be given by z=yₙ . . . y₂y₁|xₙ . . . x₂|y₀x₁x₀. Example z indexes and/or values (and corresponding base-ten values) are provided for a subset of the units in diagram 1220 for clarity, where underlined bits are from the index in the y direction/axis and the other bits are from the index in the x direction/axis.

FIG. 12D is a diagram 1230 illustrating a fourth mapping of elements of a 2D grid to a 1D index that may be associated with a 2×4 coalescing operation. Diagram 1230 illustrates a second modified “Morton order” mapping (or a second traversal pattern) that proceeds in the direction of the lines/arrows which maps groups of 8 adjacent units (e.g., contiguous and/or adjacent units shown as having a same shading associated with the 2×4 coalescing operation) to contiguous indexes of the 1D index (locations in the 1D linear array) corresponding to the 8 child nodes of a parent node in the HW structure described above. For example, the second modified “Morton order” mapping may be based on, or associated with, an index z into the 1D linear array (e.g., a 1D index). For a set of units arranged in a 2D grid indexed as described above (and illustrated in diagram 1220) the index z may be given by z=yₙ . . . y₂ |xₙ . . . x₁|y₁y₀x₀.

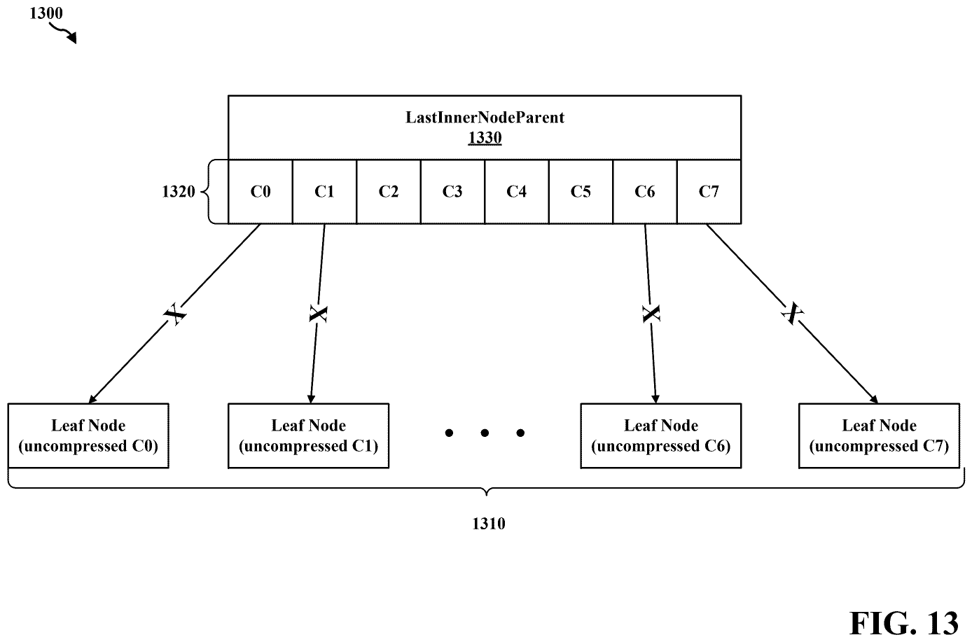

FIG. 13 is a diagram 1300 illustrating an aspect of the BVH associated with some aspects of the HW-accelerated ray tracing. Diagram 1300 illustrates that, in some aspects, when building the BVH, a lowest layer (or last) of inner nodes 1330 (e.g., parents) may store 8 child nodes (e.g., the set of child nodes 1320) with a compressed Z-value (e.g., a Z-value based on a coalescing operation for the associated depth image and/or depth map). For example, leaf nodes 1310, or values associated with a highest MIP level or a received and/or obtained depth image or depth map, may be ignored, or not stored as a child in a parent-child structure and the compressed children of the last inner node may be considered the leaves instead. A traversal algorithm may be customized to exit early, e.g., at the last inner node, and return a closest hit child such as a first child hit for a k-dimensional (K-D) tree. In some aspects, this may provide freedom to customize the BVH and the (ray) traversal algorithm.

Based on the BVH structure, a modified and/or tailored updateBVH API may be designed. In some aspects, the modified updateBVH API may be a trimmed version of the buildBVH kernel. The modified updateBVH API may include minimal code to update Z-values per leaf node. As the BVH structure may not change between depth images, the updateBVH API may be optimized to update the Z-values (e.g., to propagate changed depth values, or Z-values). Based on being able to re-use the BVH structure, the updateBVH API may execute faster than an update associated with an updated BVH structure

In some aspects, a subsequent ray tracing (or traceRays API) may be associated with a RayQuery-based closest hit kernel. In some aspects, a camera may be positioned to ensure 1-ray-per-texel and a camera distance from BVH may be calculated to encompass the BVH (e.g., assuming a 90° field of view). In some aspects, render dimensions may be equal to depth image dimensions.

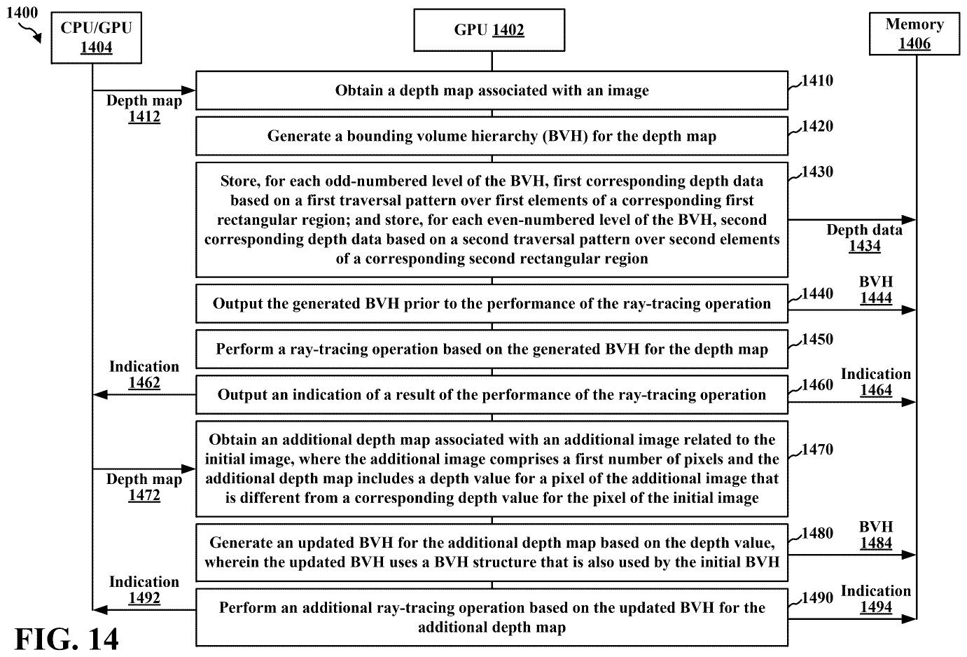

FIG. 14 is a communication flow diagram 1400 of graphics processing in accordance with one or more techniques of this disclosure. As shown in FIG. 14, communication flow diagram 1400 includes example communications between GPU 1402 (e.g., a GPU, a graphics pipeline at a GPU, a shader processor at a GPU, a streaming processor at a GPU, a GPU component, another graphics processor, a CPU, a CPU component, or another central processor), CPU/GPU 1404 (e.g., a CPU, a CPU component, or another central processor, a GPU, a graphics pipeline at a GPU, a shader processor at a GPU, a GPU component, or another graphics processor), and memory 1406 (e.g., a memory, a cache, a system memory, a graphics memory, a memory or cache at a CPU, or a memory or cache at a GPU), in accordance with one or more techniques of this disclosure.

At 1410, GPU 1402 may obtain a depth map. For example, GPU 1402 may obtain depth data 1412 from CPU/GPU 1404. In some aspects, obtaining the depth map may be associated with an image (e.g., an image to be rendered and/or displayed). The depth data 1412, in some aspects, may be obtained as part of a rendering pipeline, e.g., in association with, or to perform, a screen space reflection (SSR) rendering. In some aspects, the image may include a first number of pixels arranged in a two-dimensional (2D) grid (e.g., a 1024×1024 image or other size of image).

At 1420, the GPU 1402 may generate a BVH for the depth map. In some aspects, to generate the BVH for the depth map, the GPU 1402 may perform a plurality of coalescing operations (e.g., aggregations or mipmapping-like operations) to generate bounding volume nodes at a corresponding plurality of levels of the BVH. Sets of coalescing operations in the plurality of coalescing operations associated with odd-numbered levels of the BVH, in some aspects, may use a first rectangular region and even-numbered levels of the BVH may use a second rectangular region, where the second rectangular region is a transpose of the first rectangular region. As described above in relation to FIG. 11, the first rectangular region may be a 4×2 area/region and the second rectangular region may be a 2×4 area/region. In some aspects, the first rectangular region may alternatively be any one of 8×1, 2×4, or 1×8 with the second rectangular region being the transpose (e.g., 1×8, 4×2, or 8×1, respectively). Each bounding volume or node at a same level of the BVH may be associated with a same corresponding number of pixels of the image (e.g., a same base, or footprint, size). In some aspects, parent nodes in the BVH (or parent nodes at a same level of the BVH) are each associated with a first number of child nodes. The first number of child nodes, in some aspects, may be based on hardware associated with generating the BVH (e.g., based on the hardware being optimized to store the first number of child nodes per parent node). In some aspects, the bounding volumes (or nodes) at a same level of the BVH do not overlap. The generated BVH, in some aspects, may be associated with a height map (e.g., based on an inversion of a minimum depth value associated with child nodes and/or the depth map). The lowest level of the BVH having a smallest footprint (e.g., a smallest base or a smallest number of associated pixels/texels), in some aspects, may include coalesced depth data based on the depth map (e.g., the data in the obtained depth map may not be stored in the BVH).

At 1430, the GPU 1402 may store, for each odd-numbered level of the BVH, first corresponding depth (or height) data based on a first traversal pattern over first elements of a corresponding first rectangular region and store, for each even-numbered level of the BVH, second corresponding depth data based on a second traversal pattern over second elements of a corresponding second rectangular region. The first and second traversal patterns, in some aspects, may be the first and second traversal patterns of diagram 1220 and diagram 1230 or vice versa. For example, GPU 1402 may store depth data 1434 in memory 1406. The depth (or height) data may be stored in a HW structure configured to store an association between a parent and 8 children/child nodes.

At 1440, the GPU 1402 may output the generated BVH prior to the performance of the ray tracing operation. For example, GPU 1402 may store BVH 1444 in memory 1406. In some aspects, storing the first corresponding depth (or height) data and the second corresponding depth (or height) data (e.g., the depth data 1434) may be included in, or may be a part of, outputting the generated BVH at 1440. The BVH may be stored in a HW structure configured to store an association between a parent and 8 children/child nodes. In some aspects, the BVH may be a balanced tree, e.g., a hierarchical structure with each node associated with a particular level of the hierarchical structure having an equal number of children nodes.

At 1450, the GPU 1402 may perform a ray tracing operation based on the generated BVH for the depth map. The ray tracing operation, in some aspects, may be a HW-accelerated ray tracing operation. Based on the performance, the GPU 1402 may, at 1460, output an indication of a result of the performance of the ray tracing operation performed at 1450. In some aspects, outputting, at 1460, the indication of the result of the performance of the ray tracing operation may include transmitting the indication of the result of the performance of the ray tracing operation and/or storing the indication of the result of the performance of the ray tracing operation. The result of the performance of the ray tracing operation, in some aspects, may be an intersecting pixel and/or texel closest to an origin of a ray associated with the ray tracing operation. In some aspects, the result of the performance of the ray tracing operation (or a BVH traversal associated with the ray tracing operation) may be an intersecting bounding volume at a lowest level of the BVH that is closest to the origin of the ray associated with the ray tracing operation. The intersecting bounding volume at the lowest level of the BVH, in some aspects, may be associated with a plurality of pixels and/or texels (e.g., candidates for a closest hit pixel and/or texel) and may be used to determine the closest hit pixel and/or texel based on depth and/or height data stored (e.g., outside the BVH and/or the BVH structure) based on the depth map obtained at 1410. For example, GPU 1402 may transmit indication 1462 to CPU/GPU 1404. For example, GPU 1402 may store indication 1464 in memory 1406.

At 1470, GPU 1402 may obtain an additional depth map. For example, GPU 1402 may obtain additional depth data 1472 from CPU/GPU 1404. In some aspects, obtaining the additional depth map may be associated with an additional image (e.g., an image to be rendered and/or displayed) related to the initial image (e.g., the image associated with the depth data obtained at 1410). The depth data 1472, in some aspects, may be obtained as part of a rendering pipeline, e.g., in association with, or to perform, the SSR rendering. In some aspects, the additional image (and the additional depth map) may include the first number of pixels (in a same 2D grid as the depth map obtained at 1410) and the additional depth map includes a depth value for a pixel of the additional image that is different from a corresponding depth value for the pixel of the initial image. The pixel of the additional image that is different from the corresponding depth value for the pixel of the initial image may be one of many pixels with different depth values and the identity of the pixels having different values may be indicated to allow the updating of the heights of the bounding volumes of the BVH without changing the underlying BVH structure (e.g., the size of the bases and/or footprints of the bounding volumes, the orientation of the bounding volumes, and/or the number of nodes in the BVH).

At 1480, the GPU 1402 may generate an updated BVH for the additional depth map based on the depth value (e.g., the depth value for the pixel of the additional image that is different from the corresponding depth value for the pixel of the initial image). In some aspects, to generate the BVH for the depth map, the GPU 1402 may determine, for a node of the BVH structure associated with the depth value and based on the depth value, that corresponding depth data is different from an initial corresponding depth data for the node of the BVH structure for the initial BVH and update, based on the depth value, the corresponding depth data for the node of the BVH structure (e.g., the updated BVH structure) via BVH 1484 (which may include one or more updates to the BVH instead of a complete BVH).

At 1490, the GPU 1402 may perform an additional ray tracing operation based on the updated BVH for the additional depth map. The ray tracing operation, in some aspects, may be a HW-accelerated ray tracing operation. In some aspects, the result of the ray tracing operation may be an intersecting pixel and/or texel closest to an origin of a ray or an intersecting bounding volume at a lowest level of the BVH that is closest to the origin of the ray as discussed above in relation to performing the ray tracing operation at 1450 and outputting an indication of a result of the performance of the ray tracing operation at 1460. Based on the performance, the GPU 1402 may output an indication of a result of the performance of the ray tracing operation performed at 1490. In some aspects, outputting the indication of the result of the performance of the ray tracing operation may include transmitting the indication of the result of the performance of the ray tracing operation and/or storing the indication of the result of the performance of the ray tracing operation. For example, GPU 1402 may transmit indication 1492 to CPU/GPU 1404. For example, GPU 1402 may store indication 1494 in memory 1406.

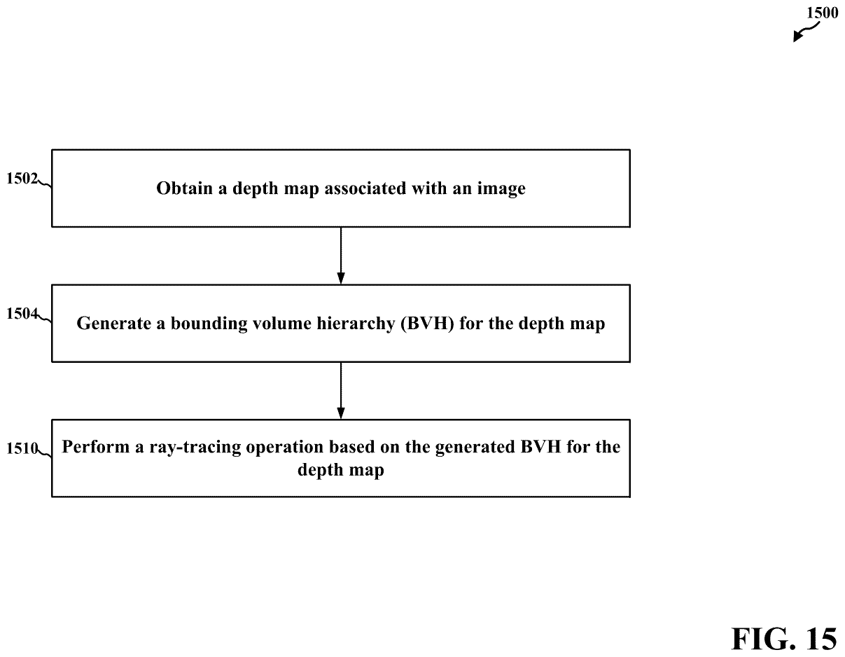

FIG. 15 is a flowchart 1500 of an example method of graphics processing in accordance with one or more techniques of this disclosure. The method may be performed by an apparatus, such as an apparatus for graphics processing, a GPU, a CPU a wireless communication device, and the like, as used in connection with the aspects of FIGS. 1-14.

At 1502, the apparatus may obtain a depth map, as described in connection with the examples in FIGS. 1-14. For example, as described in relation to 1410 of FIG. 14, GPU 1402 may obtain a depth map. Further, step 1502 may be performed by processing unit 120 or BVH builder 198 in FIG. 1. For example, GPU 1402 may obtain depth data 1412 from CPU/GPU 1404. In some aspects, obtaining the depth map may be associated with an image (e.g., an image to be rendered and/or displayed). The depth data 1412, in some aspects, may be obtained as part of a rendering pipeline, e.g., in association with, or to perform, a SSR rendering. In some aspects, the image may include a first number of pixels arranged in a 2D grid (e.g., a 1024×1024 image or other size of image).

At 1504, the apparatus may generate a BVH for the depth map, as described in connection with the examples in FIGS. 1-14. For example, as described in relation to 1420 of FIG. 14, GPU 1402 may generate a BVH for the depth map. Further, step 1504 may be performed by processing unit 120 or BVH builder 198 in FIG. 1. In some aspects, to generate the BVH for the depth map, the GPU 1402 may perform a plurality of coalescing operations (e.g., aggregations or mipmapping-like operations) to generate bounding volume nodes at a corresponding plurality of levels of the BVH. Sets of coalescing operations in the plurality of coalescing operations associated with odd-numbered levels of the BVH, in some aspects, may use a first rectangular region and even-numbered levels of the BVH may use a second rectangular region, where the second rectangular region is a transpose of the first rectangular region. As described above in relation to FIG. 11, the first rectangular region may be a 4×2 area/region and the second rectangular region may be a 2×4 area/region. In some aspects, the first rectangular region may alternatively be any one of 8×1, 2×4, or 1×8 with the second rectangular region being the transpose (e.g., 1×8, 4×2, or 8×1, respectively). Each bounding volume or node at a same level of the BVH may be associated with a same corresponding number of pixels of the image (e.g., a same base, or footprint, size). In some aspects, parent nodes in the BVH (or parent nodes at a same level of the BVH) are each associated with a first number of child nodes. The first number of child nodes, in some aspects, may be based on hardware associated with generating the BVH. In some aspects, the bounding volumes (or nodes) at a same level of the BVH do not overlap. The generated BVH, in some aspects, may be associated with a height map (e.g., based on an inversion of a minimum depth value associated with child nodes and/or the depth map). The lowest level of the BVH having a smallest footprint (e.g., a smallest base or a smallest number of associated pixels/texels), in some aspects, may include coalesced depth data based on the depth map (e.g., the data in the obtained depth map may not be stored in the BVH).

In some aspects, the apparatus may store, for each odd-numbered level of the BVH, first corresponding depth (or height) data based on a first traversal pattern over first elements of a corresponding first rectangular region and store, for each even-numbered level of the BVH, second corresponding depth data based on a second traversal pattern over second elements of a corresponding second rectangular region, as described in connection with the examples in FIGS. 1-14. For example, as described in relation to 1430 of FIG. 14, GPU 1402 may store, for each odd-numbered level of the BVH, first corresponding depth (or height) data based on a first traversal pattern over first elements of a corresponding first rectangular region and store, for each even-numbered level of the BVH, second corresponding depth data based on a second traversal pattern over second elements of a corresponding second rectangular region. The first and second traversal patterns, in some aspects, may be the first and second traversal patterns of diagram 1220 and diagram 1230 or vice versa. For example, GPU 1402 may store depth data 1434 in memory 1406. The depth (or height) data may be stored in a HW structure configured to store an association between a parent and 8 children/child nodes.

The apparatus, in some aspects, may output the generated BVH prior to the performance of the ray tracing operation, as described in connection with the examples in FIGS. 1-14. For example, as described in relation to 1440 of FIG. 14, the GPU 1402 may output the generated BVH prior to the performance of the ray tracing operation. For example, GPU 1402 may store BVH 1444 in memory 1406. In some aspects, storing the first corresponding depth (or height) data and the second corresponding depth (or height) data (e.g., the depth data 1434) may be included in, or may be a part of, outputting the generated BVH at 1440. The BVH may be stored in a HW structure configured to store an association between a parent and 8 children/child nodes. In some aspects, the BVH may be a balanced tree, e.g., a hierarchical structure with each node associated with a particular level of the hierarchical structure having an equal number of children nodes.

At 1510, the apparatus may perform a ray tracing operation based on the generated BVH for the depth map, as described in connection with the examples in FIGS. 1-14. For example, as described in relation to 1450 of FIG. 14, the GPU 1402 may perform a ray tracing operation based on the generated BVH for the depth map. Further, step 1510 may be performed by processing unit 120 or BVH builder 198 in FIG. 1. The ray tracing operation, in some aspects, may be a HW-accelerated ray tracing operation.

In some aspects, the apparatus may output an indication of a result of the performance of the ray tracing operation, as described in connection with the examples in FIGS. 1-14. For example, as described in relation to 1460 of FIG. 14, the GPU 1402 may output an indication of a result of the performance of the ray tracing operation performed at 1450. In some aspects, outputting the indication of the result of the performance of the ray tracing operation may include transmitting the indication of the result of the performance of the ray tracing operation and/or storing the indication of the result of the performance of the ray tracing operation. The result of the performance of the ray tracing operation, in some aspects, may be an intersecting pixel and/or texel closest to an origin of a ray associated with the ray tracing operation. In some aspects, the result of the performance of the ray tracing operation (or a BVH traversal associated with the ray tracing operation) may be an intersecting bounding volume at a lowest level of the BVH that is closest to the origin of the ray associated with the ray tracing operation. The intersecting bounding volume at the lowest level of the BVH, in some aspects, may be associated with a plurality of pixels and/or texels (e.g., candidates for a closest hit pixel and/or texel) and may be used to determine the closest hit pixel and/or texel based on depth and/or height data stored (e.g., outside the BVH and/or the BVH structure) based on the depth map obtained at 1410. For example, GPU 1402 may transmit indication 1462 to CPU/GPU 1404. For example, GPU 1402 may store indication 1464 in memory 1406.

The apparatus, in some aspects, may obtain an additional depth map, as described in connection with the examples in FIGS. 1-14. For example, as described in relation to 1470 of FIG. 14, the GPU 1402 may obtain an additional depth map. For example, GPU 1402 may obtain additional depth data 1472 from CPU/GPU 1404. In some aspects, obtaining the additional depth map may be associated with an additional image (e.g., an image to be rendered and/or displayed) related to the initial image (e.g., the image associated with the depth data obtained at 1502). The depth data 1472, in some aspects, may be obtained as part of a rendering pipeline, e.g., in association with, or to perform, the SSR rendering. In some aspects, the additional image (and the additional depth map) may include the first number of pixels (in a same 2D grid as the depth map obtained at 1410 or 1502) and the additional depth map includes a depth value for a pixel of the additional image that is different from a corresponding depth value for the pixel of the initial image. The pixel of the additional image that is different from the corresponding depth value for the pixel of the initial image may be one of many pixels with different depth values and the identity of the pixels having different values may be indicated to allow the updating of the heights of the bounding volumes of the BVH without changing the underlying BVH structure (e.g., the size of the bases and/or footprints of the bounding volumes, the orientation of the bounding volumes, and/or the number of nodes in the BVH).

In some aspects, the apparatus may generate an updated BVH for the additional depth map based on the depth value, as described in connection with the examples in FIGS. 1-14. For example, as described in relation to 1480 of FIG. 14, the GPU 1402 may generate an updated BVH for the additional depth map based on the depth value. In some aspects, to generate the BVH for the depth map, the GPU 1402 may determine, for a node of the BVH structure associated with the depth value and based on the depth value, that corresponding depth data is different from an initial corresponding depth data for the node of the BVH structure for the initial BVH and update, based on the depth value, the corresponding depth data for the node of the BVH structure (e.g., the updated BVH structure.

The apparatus, in some aspects, may perform an additional ray tracing operation based on the updated BVH for the additional depth map, as described in connection with the examples in FIGS. 1-14. For example, as described in relation to 1490 of FIG. 14, the GPU 1402 may perform an additional ray tracing operation based on the updated BVH for the additional depth map. The ray tracing operation, in some aspects, may be a HW-accelerated ray tracing operation. Based on the performance, the GPU 1402 may output an indication of a result of the performance of the ray tracing operation performed at 1490. In some aspects, outputting the indication of the result of the performance of the ray tracing operation may include transmitting the indication of the result of the performance of the ray tracing operation and/or storing the indication of the result of the performance of the ray tracing operation. For example, GPU 1402 may transmit indication 1492 to CPU/GPU 1404. For example, GPU 1402 may store indication 1494 in memory 1406.

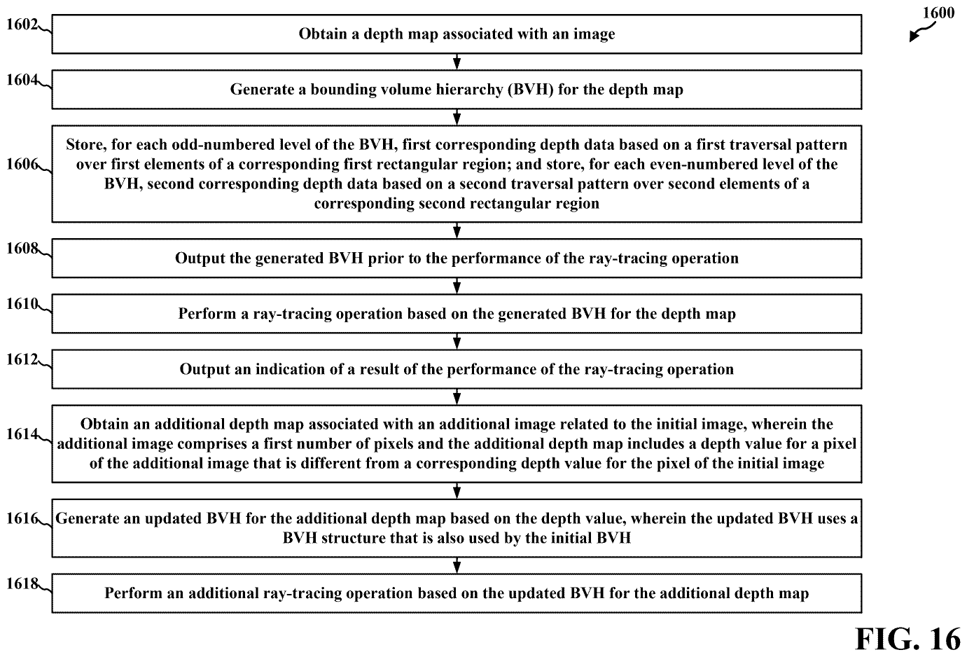

FIG. 16 is a flowchart 1600 of an example method of graphics processing in accordance with one or more techniques of this disclosure. The method may be performed by an apparatus, such as an apparatus for graphics processing, a GPU, a CPU a wireless communication device, and the like, as used in connection with the aspects of FIGS. 1-14.

At 1602, the apparatus may obtain a depth map, as described in connection with the examples in FIGS. 1-14. For example, as described in relation to 1410 of FIG. 14, GPU 1402 may obtain a depth map. Further, step 1602 may be performed by processing unit 120 or BVH builder 198 in FIG. 1. For example, GPU 1402 may obtain depth data 1412 from CPU/GPU 1404. In some aspects, obtaining the depth map may be associated with an image (e.g., an image to be rendered and/or displayed). The depth data 1412, in some aspects, may be obtained as part of a rendering pipeline, e.g., in association with, or to perform, a SSR rendering. In some aspects, the image may include a first number of pixels arranged in a 2D grid (e.g., a 1024×1024 image or other size of image).

At 1604, the apparatus may generate a BVH for the depth map, as described in connection with the examples in FIGS. 1-14. For example, as described in relation to 1420 of FIG. 14, GPU 1402 may generate a BVH for the depth map. Further, step 1604 may be performed by processing unit 120 or BVH builder 198 in FIG. 1. In some aspects, to generate the BVH for the depth map, the GPU 1402 may perform a plurality of coalescing operations (e.g., aggregations or mipmapping-like operations) to generate bounding volume nodes at a corresponding plurality of levels of the BVH. Sets of coalescing operations in the plurality of coalescing operations associated with odd-numbered levels of the BVH, in some aspects, may use a first rectangular region and even-numbered levels of the BVH may use a second rectangular region, where the second rectangular region is a transpose of the first rectangular region. As described above in relation to FIG. 11, the first rectangular region may be a 4×2 area/region and the second rectangular region may be a 2×4 area/region. In some aspects, the first rectangular region may alternatively be any one of 8×1, 2×4, or 1×8 with the second rectangular region being the transpose (e.g., 1×8, 4×2, or 8×1, respectively). Each bounding volume or node at a same level of the BVH may be associated with a same corresponding number of pixels of the image (e.g., a same base, or footprint, size). In some aspects, parent nodes in the BVH (or parent nodes at a same level of the BVH) are each associated with a first number of child nodes. The first number of child nodes, in some aspects, may be based on hardware associated with generating the BVH. In some aspects, the bounding volumes (or nodes) at a same level of the BVH do not overlap. The generated BVH, in some aspects, may be associated with a height map (e.g., based on an inversion of a minimum depth value associated with child nodes and/or the depth map). The lowest level of the BVH having a smallest footprint (e.g., a smallest base or a smallest number of associated pixels/texels), in some aspects, may include coalesced depth data based on the depth map (e.g., the data in the obtained depth map may not be stored in the BVH).

At 1606, the apparatus may store, for each odd-numbered level of the BVH, first corresponding depth (or height) data based on a first traversal pattern over first elements of a corresponding first rectangular region and store, for each even-numbered level of the BVH, second corresponding depth data based on a second traversal pattern over second elements of a corresponding second rectangular region, as described in connection with the examples in FIGS. 1-14. For example, as described in relation to 1430 of FIG. 14, GPU 1402 may store, for each odd-numbered level of the BVH, first corresponding depth (or height) data based on a first traversal pattern over first elements of a corresponding first rectangular region and store, for each even-numbered level of the BVH, second corresponding depth data based on a second traversal pattern over second elements of a corresponding second rectangular region. Further, step 1606 may be performed by processing unit 120 or BVH builder 198 in FIG. 1. The first and second traversal patterns, in some aspects, may be the first and second traversal patterns of diagram 1220 and diagram 1230 or vice versa. For example, GPU 1402 may store depth data 1434 in memory 1406. The depth (or height) data may be stored in a HW structure configured to store an association between a parent and 8 children/child nodes.

At 1608, the apparatus may output the generated BVH prior to the performance of the ray tracing operation, as described in connection with the examples in FIGS. 1-14. For example, as described in relation to 1440 of FIG. 14, the GPU 1402 may output the generated BVH prior to the performance of the ray tracing operation. For example, GPU 1402 may store BVH 1444 in memory 1406. Further, step 1608 may be performed by processing unit 120 or BVH builder 198 in FIG. 1. In some aspects, storing the first corresponding depth (or height) data and the second corresponding depth (or height) data (e.g., the depth data 1434) may be included in, or may be a part of, outputting the generated BVH at 1440. The BVH may be stored in a HW structure configured to store an association between a parent and 8 children/child nodes. In some aspects, the BVH may be a balanced tree, e.g., a hierarchical structure with each node associated with a particular level of the hierarchical structure having an equal number of children nodes.

At 1610, the apparatus may perform a ray tracing operation based on the generated BVH for the depth map, as described in connection with the examples in FIGS. 1-14. For example, as described in relation to 1450 of FIG. 14, the GPU 1402 may perform a ray tracing operation based on the generated BVH for the depth map. Further, step 1610 may be performed by processing unit 120 or BVH builder 198 in FIG. 1. The ray tracing operation, in some aspects, may be a HW-accelerated ray tracing operation.

At 1612, the apparatus may output an indication of a result of the performance of the ray tracing operation, as described in connection with the examples in FIGS. 1-14. For example, as described in relation to 1460 of FIG. 14, the GPU 1402 may output an indication of a result of the performance of the ray tracing operation performed at 1450. Further, step 1612 may be performed by processing unit 120 or BVH builder 198 in FIG. 1. In some aspects, outputting the indication of the result of the performance of the ray tracing operation may include transmitting the indication of the result of the performance of the ray tracing operation and/or storing the indication of the result of the performance of the ray tracing operation. The result of the performance of the ray tracing operation, in some aspects, may be an intersecting pixel and/or texel closest to an origin of a ray associated with the ray tracing operation. In some aspects, the result of the performance of the ray tracing operation (or a BVH traversal associated with the ray tracing operation) may be an intersecting bounding volume at a lowest level of the BVH that is closest to the origin of the ray associated with the ray tracing operation. The intersecting bounding volume at the lowest level of the BVH, in some aspects, may be associated with a plurality of pixels and/or texels (e.g., candidates for a closest hit pixel and/or texel) and may be used to determine the closest hit pixel and/or texel based on depth and/or height data stored (e.g., outside the BVH and/or the BVH structure) based on the depth map obtained at 1410. For example, GPU 1402 may transmit indication 1462 to CPU/GPU 1404. For example, GPU 1402 may store indication 1464 in memory 1406.

At 1614, the apparatus may obtain an additional depth map, as described in connection with the examples in FIGS. 1-14. For example, as described in relation to 1470 of FIG. 14, the GPU 1402 may obtain an additional depth map. Further, step 1614 may be performed by processing unit 120 or BVH builder 198 in FIG. 1. For example, GPU 1402 may obtain additional depth data 1472 from CPU/GPU 1404. In some aspects, obtaining the additional depth map may be associated with an additional image (e.g., an image to be rendered and/or displayed) related to the initial image (e.g., the image associated with the depth data obtained at 1602). The depth data 1472, in some aspects, may be obtained as part of a rendering pipeline, e.g., in association with, or to perform, the SSR rendering. In some aspects, the additional image (and the additional depth map) may include the first number of pixels (in a same 2D grid as the depth map obtained at 1410 or 1602) and the additional depth map includes a depth value for a pixel of the additional image that is different from a corresponding depth value for the pixel of the initial image. The pixel of the additional image that is different from the corresponding depth value for the pixel of the initial image may be one of many pixels with different depth values and the identity of the pixels having different values may be indicated to allow the updating of the heights of the bounding volumes of the BVH without changing the underlying BVH structure (e.g., the size of the bases and/or footprints of the bounding volumes, the orientation of the bounding volumes, and/or the number of nodes in the BVH).

At 1616, the apparatus may generate an updated BVH for the additional depth map based on the depth value, as described in connection with the examples in FIGS. 1-14. For example, as described in relation to 1480 of FIG. 14, the GPU 1402 may generate an updated BVH for the additional depth map based on the depth value. Further, step 1616 may be performed by processing unit 120 or BVH builder 198 in FIG. 1. In some aspects, to generate the BVH for the depth map, the GPU 1402 may determine, for a node of the BVH structure associated with the depth value and based on the depth value, that corresponding depth data is different from an initial corresponding depth data for the node of the BVH structure for the initial BVH and update, based on the depth value, the corresponding depth data for the node of the BVH structure (e.g., the updated BVH structure.

At 1618, the apparatus may perform an additional ray tracing operation based on the updated BVH for the additional depth map, as described in connection with the examples in FIGS. 1-14. For example, as described in relation to 1490 of FIG. 14, the GPU 1402 may perform an additional ray tracing operation based on the updated BVH for the additional depth map. Further, step 1616 may be performed by processing unit 120 or BVH builder 198 in FIG. 1. The ray tracing operation, in some aspects, may be a HW-accelerated ray tracing operation. Based on the performance, the GPU 1402 may output an indication of a result of the performance of the ray tracing operation performed at 1490. In some aspects, outputting the indication of the result of the performance of the ray tracing operation may include transmitting the indication of the result of the performance of the ray tracing operation and/or storing the indication of the result of the performance of the ray tracing operation. For example, GPU 1402 may transmit indication 1492 to CPU/GPU 1404. For example, GPU 1402 may store indication 1494 in memory 1406.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining a depth map associated with an image. The apparatus may further include means for generating a bounding volume hierarchy (BVH) for the depth map. The apparatus may further include means for performing a ray tracing operation based on the generated BVH for the depth map. The apparatus may further include means for performing a plurality of coalescing operations to generate bounding volume nodes at a corresponding plurality of levels of the BVH. The apparatus may further include means for storing, for each odd-numbered level of the BVH, first corresponding depth data based on a first traversal pattern over first elements of a corresponding first rectangular region. The apparatus may further include means for storing, for each even-numbered level of the BVH, second corresponding depth data based on a second traversal pattern over second elements of a corresponding second rectangular region. The apparatus may further include means for obtaining an additional depth map associated with an additional image related to the initial image. The apparatus may further include means for generating an updated BVH for the additional depth map based on the depth value, where the updated BVH uses a BVH structure that is also used by the initial BVH. The apparatus may further include means for performing an additional ray tracing operation based on the updated BVH for the additional depth map. The apparatus may further include means for determining, for a node of the BVH structure associated with the depth value and based on the depth value, that corresponding depth data is different from an initial corresponding depth data for the node of the BVH structure for the initial BVH. The apparatus may further include means for updating, based on the depth value, the corresponding depth data for the node of the BVH structure. The apparatus may further include means for outputting the generated BVH prior to the performance of the ray tracing operation. The apparatus may further include means for outputting an indication of a result of the performance of the ray tracing operation. The apparatus may further include means for transmitting the indication of the result of the performance of the ray tracing operation. The apparatus may further include means for storing the indication of the result of the performance of the ray tracing operation. It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, comprising: obtaining a depth map associated with an image; generating a bounding volume hierarchy (BVH) for the depth map; and performing a ray tracing operation based on the generated BVH for the depth map.

Aspect 2 is the method of aspect 1, wherein generating the BVH comprises: performing a plurality of coalescing operations to generate bounding volume nodes at a corresponding plurality of levels of the BVH, wherein sets of coalescing operations in the plurality of coalescing operations associated with odd-numbered levels of the BVH use a first rectangular region and even-numbered levels of the BVH use a second rectangular region, wherein the second rectangular region is a transpose of the first rectangular region.

Aspect 3 is the method of aspect 2, further comprising: storing, for each odd-numbered level of the BVH, first corresponding depth data based on a first traversal pattern over first elements of a corresponding first rectangular region; and storing, for each even-numbered level of the BVH, second corresponding depth data based on a second traversal pattern over second elements of a corresponding second rectangular region.

Aspect 4 is the method of any of aspects 1 to 3, wherein a lowest layer of the BVH comprises coalesced depth data based on the depth map.

Aspect 5 is the method of any of aspects 1 to 4, wherein the BVH is an initial BVH, the image is an initial image, and the method further comprises: obtaining an additional depth map associated with an additional image related to the initial image, wherein the additional image comprises a first number of pixels and the additional depth map includes a depth value for a pixel of the additional image that is different from a corresponding depth value for the pixel of the initial image; generating an updated BVH for the additional depth map based on the depth value, wherein the updated BVH uses a BVH structure that is also used by the initial BVH; and performing an additional ray tracing operation based on the updated BVH for the additional depth map.

Aspect 6 is the method of aspect 5, wherein generating the updated BVH for the additional depth map based on the depth value comprises: determining, for a node of the BVH structure associated with the depth value and based on the depth value, that corresponding depth data is different from an initial corresponding depth data for the node of the BVH structure for the initial BVH; and updating, based on the depth value, the corresponding depth data for the node of the BVH structure.

Aspect 7 is the method of any of aspects 1-6, wherein the image comprises the first number of pixels arranged in a two-dimensional (2D) grid.

Aspect 8 is the method of aspect 7, wherein nodes at a same level of the BVH are associated with a same corresponding number of pixels of the image.

Aspect 9 is the method of any of aspects 1 to 8, wherein parent nodes in the BVH are each associated with a first number of child nodes.

Aspect 10 is the method of aspect 9, wherein the first number of child nodes is based on hardware associated with generating the BVH.

Aspect 11 is the method of any of aspects 1 to 10, wherein bounding volumes at a same level of the BVH do not overlap.

Aspect 12 is the method of any of aspects 1 to 11, wherein the generated BVH is associated with a height map.

Aspect 13 is the method of any of aspects 1 to 12, further comprising outputting the generated BVH prior to the performance of the ray tracing operation.

Aspect 14 is the method of any of aspects 1 to 13, further comprising outputting an indication of a result of the performance of the ray tracing operation, wherein the result comprises one of: an intersecting pixel closest to an origin of a ray associated with the ray tracing operation; or an intersecting bounding volume at a lowest level of the BVH that is closest to the origin of the ray associated with the ray tracing operation, wherein the intersecting bounding volume is used to determine the intersecting pixel.

Aspect 15 is the method of aspect 14, wherein outputting the indication of the result of the performance of the ray tracing operation comprises: transmitting the indication of the result of the performance of the ray tracing operation; or storing the indication of the result of the performance of the ray tracing operation.

Aspect 16 is an apparatus for graphics processing including at least one processor coupled to a memory and configured to implement a method as in any of aspects 1-15.

Aspect 17 may be combined with aspect 15 and includes that the apparatus is a wireless communication device.

Aspect 18 is an apparatus for graphics processing including means for implementing a method as in any of aspects 1-15.

Aspect 19 is a computer-readable medium (e.g., a non-transitory computer-readable medium) storing computer executable code, the code when executed by at least one processor causes the at least one processor to implement a method as in any of aspects 1-15.

Various aspects have been described herein. These and other aspects are within the scope of the following claims.

What is claimed is:

1. An apparatus for graphics processing, comprising:
a memory; and
a processor coupled to the memory and, based at least in part on information stored in the memory, the processor is configured to:
obtain a depth map associated with an image;
generate a bounding volume hierarchy (BVH) for the depth map; and
perform a ray tracing operation based on the generated BVH for the depth map.

2. The apparatus of claim 1, wherein to generate the BVH, the processor is configured to:
perform a plurality of coalescing operations to generate bounding volume nodes at a corresponding plurality of levels of the BVH, wherein sets of coalescing operations in the plurality of coalescing operations associated with odd-numbered levels of the BVH use a first rectangular region and even-numbered levels of the BVH use a second rectangular region, wherein the second rectangular region is a transpose of the first rectangular region.

3. The apparatus of claim 2, wherein the processor is further configured to:
store, for each odd-numbered level of the BVH, first corresponding depth data based on a first traversal pattern over first elements of a corresponding first rectangular region; and
store, for each even-numbered level of the BVH, second corresponding depth data based on a second traversal pattern over second elements of a corresponding second rectangular region.

4. The apparatus of claim 1, wherein a lowest layer of the BVH comprises coalesced depth data based on the depth map.

5. The apparatus of claim 1, wherein the BVH is an initial BVH, the image is an initial image, and wherein the processor is further configured to:
obtain an additional depth map associated with an additional image related to the initial image, wherein the additional image comprises a first number of pixels and the additional depth map includes a depth value for a pixel of the additional image that is different from a corresponding depth value for the pixel of the initial image;
generate an updated BVH for the additional depth map based on the depth value, wherein the updated BVH uses a BVH structure that is also used by the initial BVH; and
perform an additional ray tracing operation based on the updated BVH for the additional depth map.

6. The apparatus of claim 5, wherein to generate the updated BVH for the additional depth map based on the depth value, the processor is configured to:
determine, for a node of the BVH structure associated with the depth value and based on the depth value, that corresponding depth data is different from an initial corresponding depth data for the node of the BVH structure for the initial BVH; and
update, based on the depth value, the corresponding depth data for the node of the BVH structure.

7. The apparatus of claim 5, wherein the image comprises the first number of pixels arranged in a two-dimensional (2D) grid.

8. The apparatus of claim 7, wherein nodes at a same level of the BVH are associated with a same corresponding number of pixels of the image.

9. The apparatus of claim 1, wherein parent nodes in the BVH are each associated with a first number of child nodes, wherein the first number is based on hardware associated with generating the BVH.

10. The apparatus of claim 1, wherein bounding volumes at a same level of the BVH do not overlap.

11. The apparatus of claim 1, wherein the generated BVH is associated with a height map.

12. The apparatus of claim 1, wherein the processor is further configured to:
output the generated BVH prior to the performance of the ray tracing operation.

13. The apparatus of claim 1, wherein the processor is further configured to output an indication of a result of the performance of the ray tracing operation, wherein the result comprises one of:
an intersecting pixel closest to an origin of a ray associated with the ray tracing operation; or
an intersecting bounding volume at a lowest level of the BVH that is closest to the origin of the ray associated with the ray tracing operation, wherein the intersecting bounding volume is used to determine the intersecting pixel.

14. The apparatus of claim 13, wherein to output the indication of the result of the performance of the ray tracing operation, the processor is configured to:
transmit the indication of the result of the performance of the ray tracing operation; or
store the indication of the result of the performance of the ray tracing operation.

15. The apparatus of claim 1, wherein the apparatus is a wireless communication device.

16. A method of graphics processing, comprising:
obtaining a depth map associated with an image;
generating a bounding volume hierarchy (BVH) for the depth map; and
performing a ray tracing operation based on the generated BVH for the depth map.

17. The method of claim 16, wherein generating the BVH comprises:
performing a plurality of coalescing operations to generate bounding volume nodes at a corresponding plurality of levels of the BVH, wherein sets of coalescing operations in the plurality of coalescing operations associated with odd-numbered levels of the BVH use a first traversal pattern over first elements of a first rectangular region and even-numbered levels of the BVH use a second traversal pattern over second elements of a second rectangular region, wherein the second rectangular region is a transpose of the first rectangular region.

18. The method of claim 16, wherein the BVH is an initial BVH, the image is an initial image, and the method further comprises:
obtaining an additional depth map associated with an additional image related to the initial image, wherein the additional image comprises a first number of pixels and the additional depth map includes a depth value for a pixel of the additional image that is different from a corresponding depth value for the pixel of the initial image;
generating an updated BVH for the additional depth map based on the depth value, wherein the updated BVH uses a BVH structure that is also used by the initial BVH; and
performing an additional ray tracing operation based on the updated BVH for the additional depth map.

19. The method of claim 18, further comprising:
storing, for each odd-numbered level of the BVH, first corresponding depth data based on a first traversal pattern over first elements of a corresponding first rectangular region; and
storing, for each even-numbered level of the BVH, second corresponding depth data based on a second traversal pattern over second elements of a corresponding second rectangular region.

20. A computer-readable medium storing computer executable code, the code when executed by a processor, causes the processor to:
obtain a depth map associated with an image;
generate a bounding volume hierarchy (BVH) for the depth map; and
perform a ray tracing operation based on the generated BVH for the depth map.
